(19) United States
(12) Patent Application Publication
(10) Pub. No.: US 2026/0056073 A1
(43) Pub. Date: Feb. 26, 2026

(54) SENSOR MODULE

(71) Applicants: TE Connectivity Solutions GmbH, Schaffhausen (CH); Tyco Electronics (Shanghai) Co., Ltd., Shanghai (CN)

(72) Inventors: Kun Tang, Shenzhen (CN); Yongyao Cai, Schaffhausen (CH); Weifeng Bian, Shanghai (CN); Minghui Shao, Shanghai (CN); Junyu Chen, Shanghai (CN); Chang Liu, Shanghai (CN); Jing Zhang, Shanghai (CN)

(73) Assignees: TE Connectivity Solutions GmbH, Schaffhausen (CH); Tyco Electronics (Shanghai) Co., Ltd., Shanghai (CN)

(21) Appl. No.: 19/303,815

(22) Filed: Aug. 19, 2025

(30) Foreign Application Priority Data
Aug. 20, 2024 (CN) 202411146748.2

(51) Int. Cl. G01L 19/00; G01N 21/59; G01N 27/07

(52) U.S. Cl. CPC G01L 19/0007; G01L 19/0092; G01N 21/59; G01N 27/07

(57) ABSTRACT

A sensor module includes a plurality of sensors having a first sensor and one or more second sensors, a main body having a first chamber and a second chamber, a circuit board connected to the plurality of sensors, and a housing covering the circuit board. The first sensor is a pressure sensor. One end of the first chamber allows a liquid to flow in. The one or more second sensors are installed in an other end of the first chamber. The second chamber is adjacent the other end of the first chamber and intersects with the first chamber. The second chamber has a hole provided on a side of the second chamber and a baffle plate arranged in the second chamber. The hole accommodates a part of the pressure sensor. The baffle plate is arranged along an extension direction of the second chamber and is adjacent the hole.

### CROSS-REFERENCE TO RELATED APPLICATION

This application claims the benefit of the filing date under 35 U.S.C. § 119(a)-(d) of Chinese Patent Application No. CN 202411146748.2, filed on Aug. 20, 2024.

### FIELD OF THE INVENTION

This present invention relates to the field of sensing technologies and, in particular, to a sensor module.

### BACKGROUND OF THE INVENTION

In a smart cleaning device, it is usually necessary to measure various parameters with various sensors to adapt to different working modes. In the smart cleaning device, various sensors are provided to detect parameters such as liquid level, conductivity, turbidity, and temperature of a liquid in the smart cleaning device. Generally, a liquid level sensor, a conductivity sensor, a turbidity sensor, and a temperature sensor located at different positions may be independently installed at different positions of the smart cleaning device. The various sensors need to be connected to a control system by different wiring. This method is relatively complex in wiring and structure and occupies space. Additionally, the liquid level sensor may be fixed near a liquid flow path, and the liquid is transmitted to an air channel of the liquid level sensor through an air pipe to detect the liquid level height. A measuring portion of a turbidity sensor can be inserted into the liquid flow path to detect a turbidity condition of the liquid. A temperature sensor may also be fixed in the fluid flow path to detect fluid temperature.

In some examples, the various sensors may be integrated, that is, an all-in-one sensor module is used to detect various parameters. However, such a sensor module needs to be disposed in chambers at different positions for different sensors. Therefore, the integrated structure is relatively complex, and the size of the product is also relatively large.

### SUMMARY OF THE INVENTION

A sensor module includes a plurality of sensors having a first sensor and one or more second sensors, a main body having a first chamber and a second chamber, a circuit board connected to the plurality of sensors, and a housing covering the circuit board. The first sensor is a pressure sensor. One end of the first chamber allows a liquid to flow in. The one or more second sensors are installed in an other end of the first chamber. The second chamber is adjacent the other end of the first chamber and intersects with the first chamber. The second chamber has a hole provided on a side of the second chamber and a baffle plate arranged in the second chamber. The hole accommodates a part of the pressure sensor. The baffle plate is arranged along an extension direction of the second chamber and is adjacent the hole.

### BRIEF DESCRIPTION OF DRAWINGS

The invention will now be described by way of example with reference to the accompanying figures, of which:

FIG. 1 is an exploded view of a sensor module according to an exemplary embodiment;

FIG. 2 is a left side cross-sectional view of the sensor module of FIG. 1;

FIG. 3 is a right side cross-sectional view of the sensor module of FIG. 1;

FIG. 4 is a perspective view of the sensor module of FIG. 1; and

FIG. 5 is another perspective view of the sensor module of FIG. 1.

### DETAILED DESCRIPTION

The following description further describes the technical solutions of this present disclosure in detail with reference to the accompanying drawings by using examples. In the specification, the same or similar reference signs indicate the same or similar components. The following description of the embodiments of the present disclosure, with reference to the accompanying drawings, is intended to explain the general inventive concept of the present disclosure, and should not be construed as limiting the present disclosure.

The terms “including”, “comprising”, and similar terms used herein should be understood as open terms, that is, “including/including but not limited to” means that other contents may also be included. The term “based on” means “based at least in part on. ” The term “one example” means “at least one example”; the term “another example”means “at least one additional example”, etc.

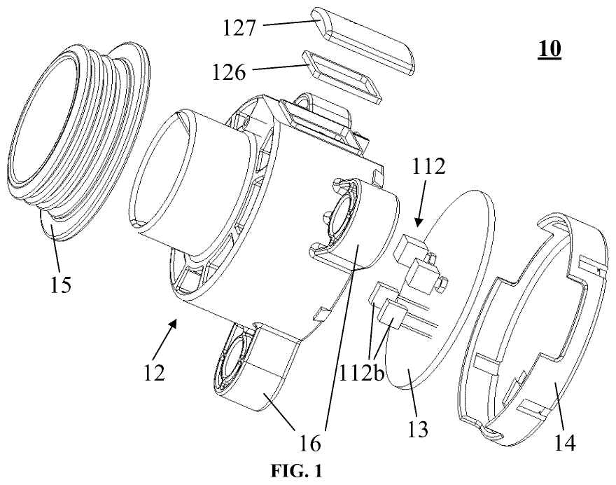

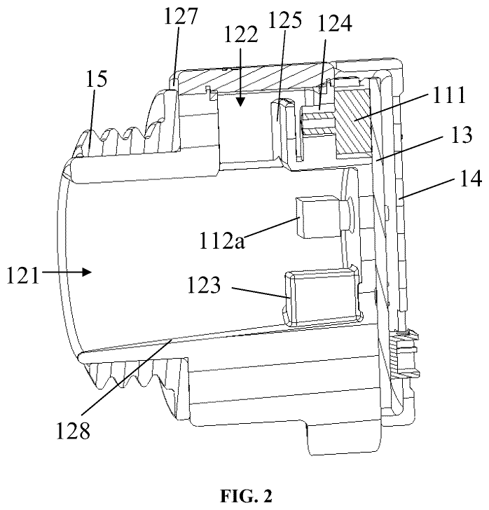

An exemplary embodiment of a sensor module 10 will now be described with reference to FIGS. 1-5. As shown in FIGS. 1-2, the sensor module 10 includes sensors 111,112, a main body 12, a circuit board 13, and a housing 14. The sensors include a first sensor 111 and one or more second sensors 112. The first sensor 111 is a pressure sensor 111, which does not need to be in contact with a liquid. The one or more second sensors 112 may be configured to detect parameters such as turbidity, conductivity, temperature, pH, and vibration of the liquid.

As shown in FIG. 2, the main body 12 includes a first chamber 121 and a second chamber 122. One end of the first chamber 121 allows liquid to flow in, and the other end of the first chamber 121 is closed and provided with one or more protrusions 123. The other end of the first chamber 121 is used to contact the circuit board 13 for coupling sensors 111,112 to the circuit board 13. The one or more protrusions 123 protrude toward the interior of the first chamber 121. The one or more protrusions 123 are used to accommodate the one or more second sensors 112. In an embodiment, the first chamber 121 may be cylindrical, with an inner diameter of the first chamber 121 that is cylindrical being between 20 mm and 30 mm, which is sufficient to accommodate the sensors 111,112. In various other embodiments, the first chamber 121 may have other shapes, such as a cubic shape.

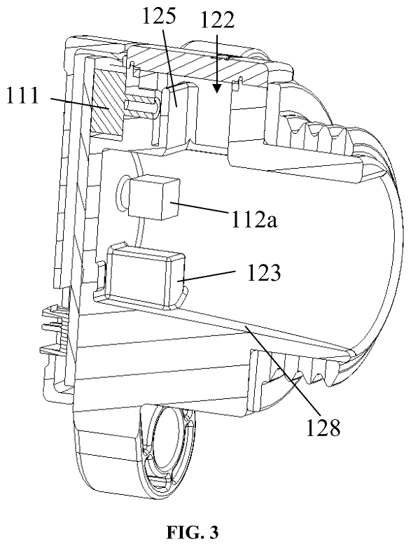

As shown in FIG. 2, the second chamber 122 is located near the other end of the first chamber 121 and intersects the first chamber 121. A hole 124 is provided on a side of the second chamber 122. The hole 124 is configured to accommodate a part of the pressure sensor 111, for example, a pressure cavity of the pressure sensor 111. As shown in FIG. 2, the hole 124 is a cylindrical channel. The pressure sensor 111, as shown in FIGS. 2-3, may be embedded in the main body 12 through the hole 124. An end of the main body of the pressure sensor 111 may be flush with an end of the main body 12. When the liquid flows into the first chamber 121, the air in the first chamber 121 is pressed into the second chamber 122. The pressure sensor 111 acquires the magnitude of the liquid level by detecting a difference in pressure.

As shown in FIGS. 2-3, a baffle plate 125 is disposed in the second chamber 122. The baffle plate 125 is located in the second chamber 122, and the baffle plate 125 is disposed along an extending direction of the second chamber 122 and is close to the hole 124. The baffle plate 125 is spaced apart from the hole 124 by, for example, several millimeters. The baffle plate 125 is not in contact with a probe of the pressure sensor 111. The baffle plate 125 can prevent the liquid flowing into the sensor module 10 from contacting the pressure sensor 111, thereby ensuring the reliability of the pressure sensor 111.

As shown in FIG. 2, the second chamber 122 has a cubical shape. It should be understood that in other embodiments, the second chamber 122 may also have other shapes, such as a cylindrical shape.

The circuit board 13 may be connected to pins of the sensors 111,112. For example, the circuit board 13 may be a printed circuit board (PCB) signally coupled to the sensors 111,112 through pins. As shown in FIG. 1, multiple second sensors 112 are mounted on the circuit board 13, and the housing 14 is used to cover the circuit board 13.

The assembled sensor module 10 may be mounted near a water outlet of a smart cleaning device. The smart cleaning device may be a washing machine, a dishwasher, a floor washer, etc. In the assembled state, the first chamber 121 is horizontally disposed, and the second chamber 122 is vertically disposed. After the liquid flows into the first chamber 121, the first sensor 111 and the second sensor 112 may detect various parameters of the liquid. The first sensor 111 is not in contact with the liquid, and the second sensor 112 may be in contact with the liquid.

As shown in FIG. 2, in the sensor module 10, the sensors 111,112 are integrated in interconnected chambers on the same main body 12, where the pressure sensor 111 is adjacent to the second chamber 122, and other sensors 112 are all located in the first chamber 121. This integrated mechanism reduces the structural complexity of the sensor module 10 and allows for a reduction in product size, which reduces costs. In addition, the structure of the sensor module 10 facilitates modular design and assembly to accommodate a variety of different parameter detections.

In some embodiments, the pressure sensor 111 and the main body 12 are integrally formed. Specifically, as shown in FIGS. 2-3, the probe portion of the pressure sensor 111 is inserted into the hole 124 of the main body 12. The pressure sensor 111 may be embedded in the hole 124 when the main body 12 is manufactured. The pin of the pressure sensor 111 may be inserted and soldered to the circuit board 13 during assembly. The integral arrangement of the pressure sensor 111 and the hole 124 of the main body 12 can ensure the air tightness of the pressure sensor 111.

As shown in FIG. 1, the main body 12 includes a sealing gasket 126 and a sealing cover 127. One end of the second chamber 122 leads into the first chamber 121, and the other end of the second chamber 122 is sealed by the sealing gasket 126 and the sealing cover 127. The sealing gasket 126 surrounds the other end of the second chamber 122, and the sealing cover 127 covers the other end of the second chamber 122. In some embodiments, when the main body 12 and the pressure sensor 111 are integrally formed, since the demolding directions on the molds of the first chamber 121 and the second chamber 122 are different, the arrangement of the sealing gasket 126 and the sealing cover 127 is beneficial to demolding.

The pressure sensor 111, in some embodiments, is a Micro Electromechanical System (MEMS) sensor. In some embodiments, the second sensor 112 includes a turbidity sensor, which includes a light emitting unit and a light receiving unit. Correspondingly, as shown in FIG. 3, the main body 12 includes a pair of opposite and spaced apart protrusions 123 arranged opposite each other on both sides of the first chamber 121. The pair of protrusions 123 are respectively configured to accommodate the light emitting unit and the light receiving unit of the turbidity sensor. When the main body 12 and the circuit board 13 are assembled, the light emitting unit and the light receiving unit may be inserted into the pair of protrusions 123. In some embodiments, the pair of protrusions 123 are transparent. The main body 12, in some embodiments, is made of a transparent material, such as PVC, PE, PET, or PMMA.

In some embodiments, the second sensors 112 include a conductivity sensor. As shown in FIGS. 2-4, the conductivity sensor includes a pair of conductive metal blocks 112a that may be coupled to the circuit board 13 through one side of the main body 12. When the liquid flows into the first chamber 121 and immerses the conductive metal blocks 112a, the conductivity information of the liquid may be sensed.

The second sensors 112, as shown in FIGS. 1-4, are merely exemplary, and in some embodiments, the second sensors 112 may further include another type of sensor, for example, one or more of a temperature sensor, an acceleration sensor, and a microphone. As shown in FIGS. 1-2, the sensors 112a and 112b may be connected to the circuit board 13 through pins, and respective probe portions may extend into the main body 12. In various other embodiments, the second sensor 112 is a semiconductor sensor, which is directly attached to the surface of the circuit board 13.

In some embodiments, the bottom of the second chamber 122 may include an inclined portion 128. For example, as shown in FIGS. 2-3 and 5, the inclined portion 128 is flat and inclined downward toward the outside of the sensor module 10. When the flowing liquid is dirty, the setting of the inclination slope of the inclined portion 128 can reduce the accumulation of precipitates in the sensor module 10.

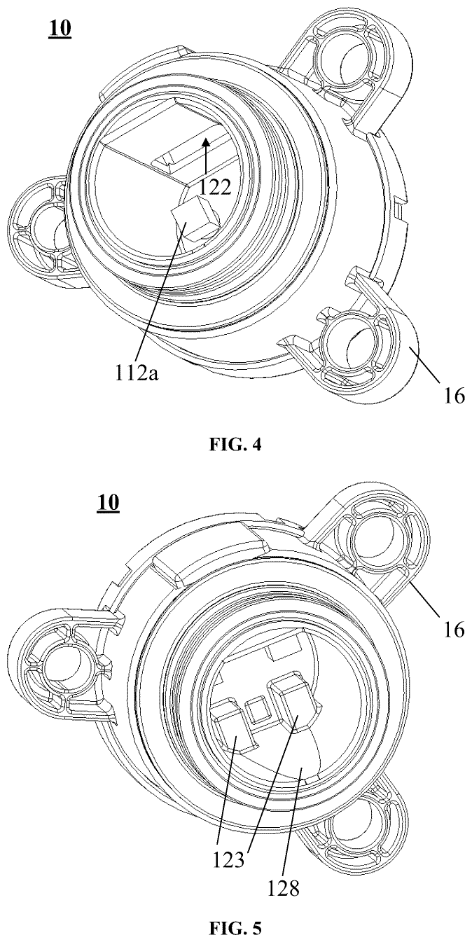

In some embodiments, as shown in FIG. 1, the sensor module 10 may further include a sealing ring 15, which surrounds the outside of one end of the second chamber 122 of the main body 12. When the sensor module 10 is mounted on an external device, the sealing ring 15 can increase the sealing performance. The sensor module 10 may further include multiple fixing members 16. For example, as shown in FIGS. 4-5, three fixing members 16 are evenly spaced on the outer periphery of the main body 12. The fixing members 16 may fix the sensor module 10 to the external device. The fixing manner may be various manners, such as threaded connection or riveting.

The foregoing descriptions are merely exemplary embodiments of the present disclosure, and are not intended to limit the embodiments of the present disclosure. Consequently, various modifications and changes may be made to the embodiments of the present disclosure by a person skilled in the art. Any modification, equivalent replacement, or improvement made without departing from the spirit and principle of the embodiments of this present disclosure shall be included in protection of the embodiments of the present disclosure.

Although the embodiments of the present disclosure have been described with reference to several specific embodiments, it should be understood that the embodiments of the present disclosure are not limited to the disclosed embodiments. The embodiments of the present disclosure are intended to cover various modifications and equivalent arrangements included within the spirit and scope of the appended claims. The scope of the appended claims is to be accorded the broadest interpretation so as to encompass all such modifications and equivalent structures and functions.

1. A sensor module, comprising:
a plurality of sensors including a first sensor and one or more second sensors, the first sensor is a pressure sensor;
a main body including a first chamber and a second chamber, one end of the first chamber allows a liquid to flow in, the one or more second sensors are installed in an other end of the first chamber, the second chamber is adjacent the other end of the first chamber and intersects with the first chamber, the second chamber has a hole provided on a side of the second chamber and a baffle plate arranged in the second chamber, the hole accommodates a part of the pressure sensor, the baffle plate is arranged along an extension direction of the second chamber and is adjacent the hole;
a circuit board connected to the plurality of sensors; and
a housing covering the circuit board.

2. The sensor module of claim 1, wherein the pressure sensor and the main body are integrally formed.

3. The sensor module of claim 1, wherein the main body has a sealing gasket.

4. The sensor module of claim 3, wherein the main body has a sealing cover.

5. The sensor module of claim 4, wherein the sealing gasket and the sealing cover seal an end of the second chamber.

6. The sensor module of claim 1, wherein the one or more second sensors include a turbidity sensor including a light emitting unit and a light receiving unit.

7. The sensor module of claim 6, wherein the other end of the first chamber has a pair of protrusions arranged opposite each other, the pair of protrusions protrude toward an interior of the first chamber, the pair of protrusions accommodate the light emitting unit and the light receiving unit.

8. The sensor module of claim 7, wherein the pair of protrusions are transparent.

9. The sensor module of claim 1, wherein the one or more second sensors include a conductivity sensor, the conductivity sensor includes a pair of conductive metal blocks.

10. The sensor module of claim 1, wherein the one or more second sensors include one or more of a temperature sensor, an acceleration sensor, and a microphone.

11. The sensor module of claim 1, wherein the pressure sensor is a MEMS sensor.

12. The sensor module of claim 1, wherein a bottom of the first chamber includes an inclined portion, the inclined portion is flat and inclined downward toward an outside of the sensor module.

13. The sensor module of claim 1, further comprising a sealing ring, the sealing ring is disposed around an outside of an end of the second chamber.

14. The sensor module of claim 1, further comprising a plurality of fixing members, the plurality of fixing members are disposed outside the main body, the plurality of fixing members fix the sensor module to an external device.

15. The sensor module of claim 1, wherein the main body is made of a transparent material.

16. The sensor module of claim 1, wherein the baffle plate is spaced apart from the hole.

17. The sensor module of claim 16, wherein the baffle plate does not contact a probe of the pressure sensor.

18. The sensor module of claim 17, wherein the baffle plate prevents the liquid flowing into the first chamber from contacting the pressure sensor.
